(19) United States
(12) Patent Application Publication
(10) Pub. No.: US 2017/0132894 A1
(43) Pub. Date: May 11, 2017

(54) VEHICLE WARNING METHOD AND DEVICE

(71) Applicant: Leauto Intelligent Technology (BEIJING) Co., Ltd., Beijing (CN)

(72) Inventor: Yongyou Fan, Beijing (CN)

(21) Appl. No.: 14/967,135

(22) Filed: Dec. 11, 2015

(30) Foreign Application Priority Data
Nov. 10, 2015 (CN) 201510762907.6

(51) Int. Cl. G08B 21/02; B60Q 9/00

(52) U.S. Cl. CPC G08B 21/02; B60Q 9/00

(57) ABSTRACT

The present disclosure discloses a vehicle warning method and the device thereof, used to solve the problem that danger may happen when an active human or object is left in a vehicle. The method includes: detecting whether an active voice exist inside the vehicle after it is determined that the vehicle is locked; if yes, sending a warning message. In the present disclosure, the problem that a danger may happen when an active person or object is left in a vehicle is solved, and the active voice in the vehicle interior is detected, by the means, human or object with less activity may also be detected correctly, thusly preventing situations such as detecting miss, and improving detecting accuracy.

### CROSS-REFERENCE TO RELATED APPLICATIONS

This present disclosure is based upon and claims priority to Chinese Patent Application No. CN201510762907.6, filed Nov. 10, 2015, the entire contents of all of which are incorporated herein by reference.

### FIELD OF TECHNOLOGY

The present disclosure relates to the field of automobile electronic technology, and more particularly to a vehicle warning method and device thereof.

### BACKGROUND

As fast development of science and technology, automobile industry is also blooming. Nowadays, vehicles have been a type of transport media which they would prefer, vehicles not only serve as travel tools of personal commuting and traveling, etc., but also serve as shuttle bus of companies and schools, etc., which may provide great convenience for people.

Recently more and more children may also ride in a vehicle, such as ride a personal vehicle when going on a tour with family, ride on a school bus when going to school or back home. However, a case in which children may be left in the vehicle may happen due to careless of part of parents or teachers, because children may be too young to understand the danger extent and are lack of self-help common sense, which would lead to danger occur to the children. Therefore, how to avoid the type of danger has been a problem demanding prompt solution at present.

### SUMMARY

The present disclosure provides a vehicle warning method and device thereof, in order to solve the problem that danger may occur when active persons or objects are left in the vehicle.

An embodiment of the present disclosure provides a vehicle warning method, including:

detecting whether an active voice exists in the vehicle after determining the vehicle is locked;

if the active voice exists in the vehicle, sending warning message.

An embodiment of the present disclosure provides a vehicle warning device, including:

a detecting module, configured to detect whether an active voice exists in the vehicle after determining the vehicle is locked;

a warning module, configured to send warning message when the detecting module detects the active voice exists in the vehicle.

An embodiment of the present disclosure provides a vehicle warning device, including:

at least one processor;

a memory for storing at least one instruction executable by the processor;

wherein the processor is configured to:

detect whether an active voice exists inside a vehicle after determining the vehicle is locked;

send a warning message if the active voice exists.

In the vehicle warning device provided by the embodiment of the present disclosure, it is capable of detecting whether active voice exists in the vehicle after the vehicle is determined to be locked, if exists, it is capable to determine that active persons or objects exists in the vehicle, at that moment, a warning message is send out to remind the vehicle owner. Therefore, in the embodiment of the present disclosure, it is capable to avoid the problem that dangers may occur when active persons or objects are left in the vehicle, and the manner of detecting the active voice in the vehicle is employed, less active persons or objects may also be detected, thus preventing detecting malfunction etc. and improve the detecting accuracy.

### BRIEF DESCRIPTION OF THE DRAWINGS

In order to more apparently describe the technical schemes in the embodiments of the disclosure or in the prior art, accompanying figures necessarily used in the description of the embodiments or the prior art will be simply explained hereinafter. Obviously, the accompanying figures described below will form the embodiments of the disclosure. An ordinary person skilled in the art may conceive further figures in accordance with these accompanying figures without contributing creative labor.

FIG. 1 is a flow chart showing steps of a vehicle warning method in the first embodiment of the present disclosure.

FIG. 2 is a flow chart showing steps of a vehicle warning method in the second embodiment of the present disclosure.

FIG. 3 is a structure block diagram showing a vehicle warning device in the third embodiment of the present disclosure.

FIG. 4 is a structure block diagram showing a vehicle warning device in the fourth embodiment of the present disclosure.

FIG. 5 is a block diagram schematically showing the vehicle warning device according to the present disclosure.

FIG. 6 is a schematic diagram showing a memory for saving or carrying instructions according to the present disclosure.

### DETAILED DESCRIPTION OF THE EMBODIMENTS

In order that objectives, technical schemes and advantages of the embodiments of the disclosure become more apparent, the technical schemes in the embodiments of the disclosure will be thoroughly and completely described below in conjunction with the accompanying figures in the embodiments of the disclosure. It is obvious that the embodiments described herein are some of embodiments of the disclosure rather than entire embodiments. On the basis of the embodiments of the disclosure, other embodiments conceived by an ordinary person skilled in the art without creative labor would all fall into the protection scope of the disclosure.

### First Embodiment

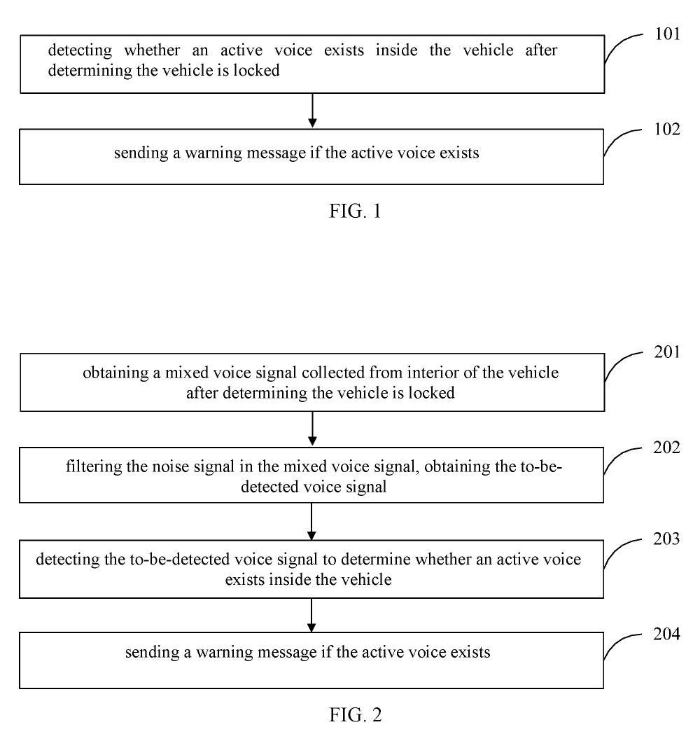

Referring to FIG. 1, which illustrates a flow chart showing the steps of a vehicle warning method in the first embodiment of the present disclosure.

The vehicle warning method in the embodiment of the present disclosure may include steps as follows:

Step 101, detecting whether an active voice exist inside the vehicle after determining the vehicle is locked.

In the embodiment of the present disclosure, vehicle locking refers to the vehicle owner locks the vehicle initiatively after the vehicle is parked and the vehicle owner leaves the vehicle. For the problem which the vehicle owner may leave the active persons or objects in the vehicle after he or she leaves and locks the vehicle, in the embodiment of the present disclosure, it is capable to detect whether active persons or objects exist in the vehicle after the vehicle is determined to be locked.

Further, given that the persons or objects such as babies left in the vehicle is less active, a common mechanical detecting method may have detecting malfunction. For example, when it is detected through the manner of detecting the pressure or vibration from the seat, due to the persons or objects left in the vehicle may be less active, pressure and vibration generated by the persons or objects left in the vehicle are also less, therefore the persons or objects of that type would not be accurately detected to be exist. For this case, in the embodiment of the present disclosure, it is preferable to employ the manner of detecting the active voice in the vehicle to determine whether active persons or objects exist in the vehicle, even if the persons or objects exist in the vehicle are less active, the active voice generated by the persons or objects may also be detected accurately, thus the precision of detection is improved.

Step 102, if exists, sending warning message.

If active voice is detected in the vehicle at step 101, it is indicated that active persons or objects are left in the vehicle, thus the vehicle may send warning message to remind the vehicle owner to deal with the case.

In the vehicle warning method provided by the embodiment of present disclosure, it is capable of detecting whether active voice exists in the vehicle after the vehicle is determined to be locked, if exists, it is capable to determine that active persons or objects exists in the vehicle, at that moment, a warning message is send out to remind the vehicle owner. Therefore, in the embodiment of the present disclosure, it is capable to avoid the problem that dangers may occur when active persons or objects are left in the vehicle, and the manner of detecting the active voice in the vehicle is employed, less active persons or objects may also be detected, thus preventing detecting malfunction etc. and improve the detecting accuracy.

### Second Embodiment

Referring to FIG. 2, it is a flow chart showing the steps of the vehicle warning method in the second embodiment of the present disclosure.

The vehicle warning method in the embodiment of the present disclosure includes steps as follows:

Step 201, obtaining a mixed voice signal collected from interior of the vehicle after determining the vehicle is locked.

In the embodiment of the present disclosure, it is capable to send a locking signal to the vehicle after the vehicle is parked and the vehicle owner leaves the vehicle and locks the vehicle initiatively. For example, a locking signal may be sent when the vehicle owner presses the locking button at the vehicle key, the vehicle determines that the vehicle is locked after receiving the locking signal.

After the vehicle is locked, if active person or object is left inside the vehicle, active person or object may generate sound. Except for the sound, noise from exterior environment where the vehicle is located may also transmit to the interior of the vehicle. At that moment, sound existing in the interior of the vehicle may be the mixture of sound made by the person or object above, and the noise transmitted from outside. In the embodiment of the present disclosure, a collecting apparatus may be used to collect mixed voice signal inside the vehicle, wherein the mixed voice signal includes a useful voice signal (signal corresponding to the sound made by the above person or object) generated inside the vehicle, and the noise signal transmitted to the interior of the vehicle from the exterior of the vehicle (signal corresponding to the noise transmitted from exterior of the vehicle). What should be noted is, the noise from exterior of the vehicle may have attenuation during transmitting into the interior of the vehicle, thusly the noise signal included in the mixed voice signal collected by a first sampling apparatus is the noise signal of the noise from the exterior of the vehicle after attenuation.

During practical application, based on special usage circumstance of the vehicle, it is capable to mount a first collecting apparatus inside the vehicle, and a second collecting apparatus outside the vehicle. The first collecting apparatus is used to collect the mixed voice signal inside the vehicle, and the second collecting apparatus is used to collect the noise signal outside the vehicle. Preferably, the first collecting apparatus in the embodiment may be a main microphone (Main Mic), and the second collecting apparatus may be a noise microphone (Err Mic). What should be noted is, the second collecting apparatus may not only be mounted outside the vehicle, but also be mounted inside the vehicle. When mounted inside the vehicle, the relation between the mounting position of the second collecting apparatus and the mounting position of the first collecting apparatus may be restricted strictly, the error of the position relation may lead to detecting error. When mounting the second collecting apparatus outside the vehicle, it is needn't to consider the mounting position of the first collecting apparatus. As a result, in the embodiment of the present disclosure, in order to reduce complexity, it is preferably to mount the second collecting apparatus outside the vehicle.

Step 202, filtering the noise signal in the mixed voice signal, obtaining the to-be-detected voice signal.

Since the mixed voice signal includes a useful voice signal generated inside the vehicle and noise signal transmitted from exterior of the vehicle to the interior of the vehicle, when detecting whether active person or object exist inside the vehicle (that is whether active voice exists), the useful voice signal generated inside the vehicle should be detected, thusly, after obtaining the above mixed voice signal, it is necessary to filter the noise inside the vehicle, that is filtering the noise signal in the mixed voice signal. it should be noted that, since it is unable to achieve an ideal filtering condition during filtering the noise signal, the to-be-detected voice signal not only include the useful voice signal, but also include a small part of noise signals that is not filtered, the detailed situation may be determined according to filtering fineness.

In the embodiment of the present disclosure, a noise suppression (NS) technology may be employed to filter the noise signal in the mixed voice signal, the step 202 may include sub-steps of:

Sub-step a1, analyzing the mixed voice signal to recognize the noise signal;

Sub-step a2, removing the mixed voice signal from the noise signal, obtaining the to-be-detected voice signal.

To the detailed process of filtering, a skilled person in the art may employ any suitable NS algorithm to process according to actual experience, which is not limited in the embodiment of the present disclosure. For example, a power spectrum subtraction may be used to perform filtering, the power spectrum subtraction is a technology to eliminate noise. Assuming noise signal is irrelative to voice signal, the nose signal and the voice signal are capable of having superposition, the noise signal has small fluctuation, and thus may be used under the condition of estimating noise power spectrum of noise mixed with voice from noise power spectrum of adjacent pure noise section. The technology is based on direct estimation of short-time power spectrum amplitude, whose basic principle is to subtract power spectrum of noise from power spectrum of mixed voice. In addition, for example it may also employ a wavelet transform method to filter, the wavelet transform method includes three basic steps: performing a wavelet transformation to the mixed voice signal including the noise signal; processing the wavelet coefficient obtained after transformation to eliminate the noise included therein; performing an inverse wavelet transformation to the processed wavelet coefficient to obtain a denoising signal. In addition, for example, a subspace method may also be employed to perform filtering. The vector space of voice signal with noise may be considered as a subspace of signal with superposition noise and a subspace of pure noise, a signal subspace process technology may be used to eliminate the pure noise subspace, and estimate the voice signal to enhance voice. The subspace method is to divide the whole space into two independent subspaces by space dividing, that is noise subspace and signal subspace with superposition noise, then process the noise subspace and the signal subspace to realize voice enhancement. The skilled person in the art may process the detailed steps of the noise suppression method differently according to the actual experience, the embodiment of the present disclosure does not illustrate in detail.

Step 203, detecting the to-be-detected voice signal to determine whether an active voice exists inside the vehicle.

After obtaining the to-be-detected voice signal by filtering, it is capable to further detect the to-be-detected voice signal to determine whether an active voice exists inside the vehicle. Preferably, in the embodiment of the present disclosure, a VAD (voice activity detection) may be used to detect the to-be-detected voice signal, the step 203 may include sub-steps of:

Sub-step b1, calculating a power value of the to-be-detected voice signal in a preset time period;

The to-be-detected voice signal obtained by filtering process in step 202 includes a plurality of voice sampling points, each sampling point corresponds to an amplitude value respectively. The process of sub-step b1 may be: calculating sum of squares of the amplitude value of the sampling point included in the to-be-detected voice signal in the preset time period, taking the sum of squares as the power value of the to-be-detected voice signal in the preset time period. Calculating the power value in the to-be-detected voice signal in the preset time period may also be represented by the formula of:

Eng=Σᵢ^{i+k}xᵢ²

In the formula, i=0, 1, 2 . . . ; k is a constant value, representing the value of preset time period; xᵢ represents the value of PCM (pulse code modulation) of the i^{th} sampling point, that is the amplitude value of the i^{th} sampling point.

Sub-step b2, comparing the power value with a preset power threshold value;

Sub-step b3, if the power value is larger than the power threshold value, determining that an active voice exists inside the vehicle, if not, determining an active voice does not exist inside the vehicle.

In the embodiment of the present disclosure, a power threshold value may be pre-set for comparing with the power value, when the power value obtained by calculation is larger than the power threshold value, it may be determined that an active voice exists inside the vehicle, if not, it is determined that no active voice exists inside the vehicle. If an active person or object inside the vehicle makes sound, the power value of the to-be-detected voice signal obtained after filter is larger than zero, and the larger the sound is, the larger the power value is. If an active person or object does not exist inside the vehicle, in ideal condition, the sound inside the vehicle after filter should be mute, that is, the power value of the to-be-detected voice signal obtained after filter is zero. However, as stated in step 202, as filtering noise signal may not reach an ideal state, the power value of the to-be-detected voice signal after filter may be larger than zero. In addition, the larger the preset time period is, the larger the power value is. As a result, the selection of the power threshold value is related to the value of the preset time period and the fineness of filtering the noise, setting the power threshold value to be too small may lead to mis-warning situation. and setting the power threshold value to be too large may lead to fail-to-warning situation. As a result, a skilled person in the art may set the power threshold value according to actual situations, the embodiment of the present disclosure does not limit the detailed value.

It should be noted that, step 201 to step 203 may be detailed process of step 101 in the first embodiment.

Step 204, if exists, sending the warning message.

If it is determined an active voice exists inside the vehicle in step 203, it means an active person or object is left inside the vehicle, at that moment, the vehicle sends a warning message to remind the owner to deal with the case. After warning, the detecting process in step 203 may be executed again. If it is determined that the active voice does not exist inside the vehicle in step 203, there is no need to warn, and the detecting process in step 203 may be executed again.

Preferably, in the embodiment of the present disclosure, warning may at least one means of text warning, light warning and sound warning. The step of sending the warning message may include:

Sub-step c1, sending text warning message to a mobile terminal which establishes connection with the vehicle via wireless network; for example, it is capable to establish connection between vehicle owner's mobile phone with the vehicle, when the owner needs to be warned, it is capable to send message such as short message including warning content to the vehicle owner's mobile phone.

And/or,

Sub-step c2, starting light of the vehicle to send light warning message;

And/or

Sub-step c3, starting alarm of the vehicle to send sound warning message.

That is, the step of sending warning message may include at least one sub-step of the above sub-step c1, sub-step c2 and sub-step c3, namely, any one sub-step may be included, and any two sub-steps may be included, or all three sub-steps may be included.

In the embodiment of the present disclosure, it is capable to detect whether active person or object is left in the vehicle, and send warning according to corresponding situation. Therefore the embodiments of the present disclosure may avoid the problem that danger may occur when active person or object is left in the vehicle, and the manner of detecting the active voice in the vehicle is employed to improve the detecting accuracy.

To the embodiments of the abovementioned methods, to describe concisely, they are described as a series of action combination. However, a skilled person in the art may know, the present disclosure is not limited to the sequence of the action. Because according to the present disclosure, some steps may be performed with other sequence, or performed at the same time. In addition, a skilled person in the art may know, the embodiments described in the specification are only preferred embodiments, the actions and modules related thereto are not necessary in the present disclosure.

### The Third Embodiment

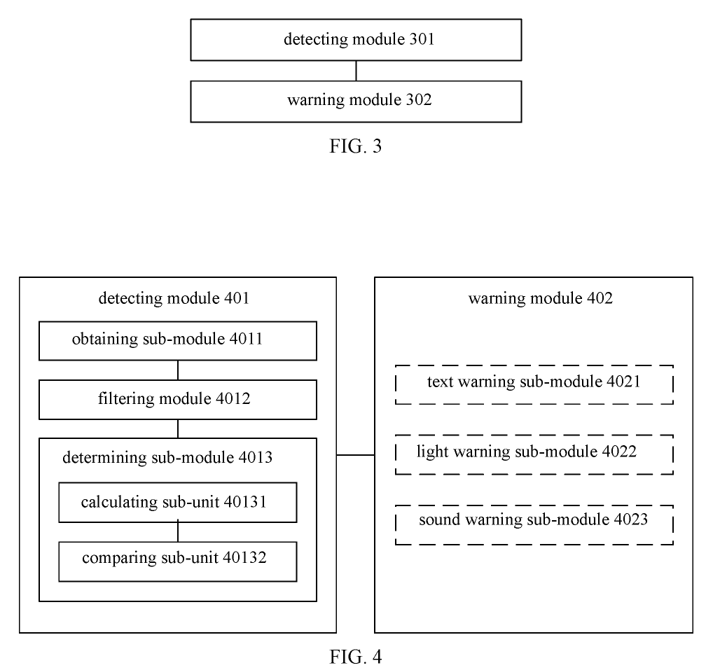

As shown in FIG. 3, it is a block diagram showing the structure of the vehicle warning device in the third embodiment of the present disclosure.

The vehicle warning device in the embodiment of the present disclosure may include modules of:

a detecting module 301, configured to detect whether an active voice exists inside the vehicle after determining the vehicle is locked;

a warning module 302, configured to send a warning message if the active voice exists.

In the vehicle warning device provided by the embodiment of present disclosure, it is capable of detecting whether active voice exists in the vehicle after the vehicle is determined to be locked, if exists, it is capable to determine that active persons or objects exists in the vehicle, at that moment, a warning message is send out to remind the vehicle owner. Therefore, in the embodiment of the present disclosure, it is capable to avoid the problem that dangers may occur when active persons or objects are left in the vehicle, and the manner of detecting the active voice in the vehicle is employed, less active persons or objects may also be detected, thus preventing detecting malfunction etc. and improve the detecting accuracy.

### The Fourth Embodiment

Referring to FIG. 4, it is a block diagram showing the structure of the vehicle warning device in the fourth embodiment of the present disclosure.

The vehicle warning device in the embodiment of the present disclosure may include modules as follows:

a detecting module 401, configured to detect whether an active voice exists inside the vehicle after determining the vehicle is locked;

a warning module 402, configured to send a warning message if the active voice exists.

Preferably, the detecting module 401 may include sub-modules of:

an obtaining sub-module 4011, configured to obtain a mixed voice signal collected from the interior of the vehicle, the mixed voice signal including useful voice signal generated inside the vehicle and noise signal transmitted from exterior of the vehicle to the interior of the vehicle;

a filtering sub-module 4012, configured to filter the noise signal in the mixed voice signal to obtain the to-be-detected voice signal;

a determining sub-module 4013, configured to detect the to-be-detected voice signal to determine whether the active voice exists inside the vehicle.

Preferably, the determining sub-module 4013 may include: a calculating sub-unit 40131, configured to calculate a power value of the to-be-detected voice signal in a preset time period; a comparing sub-unit 40132, configured to compare the power value with a preset power threshold value, and determine the active voice exists inside the vehicle if the power value is larger than the power threshold value.

Preferably, the to-be-detected voice signal includes a plurality of voice sampling points, each sampling point corresponds to an amplitude value respectively, the calculating sub-unit is concretely configured to calculate sum of squares of the amplitude value of the sampling point included in the to-be-detected voice signal in the preset time period, taking the sum of squares as the power value of the to-be-detected voice signal in the preset time period.

Preferably, the warning message 402 may include sub-modules of:

a text warning sub-module 4021, configured to send a text warning message to the mobile terminal which establishes connection with the vehicle via wireless network;

and/or,

a light warning sub-module 4022, configured to start a light of the vehicle to generate light warning message;

and/or

a sound warning sub-module 4023, configured to start an alarm of the vehicle to generate sound warning message.

In the embodiment of the present disclosure, it is capable to detect whether active person or object is left in the vehicle, and send warning according to corresponding situation. Therefore the embodiments of the present disclosure may avoid the problem that danger may occur when active person or object is left in the vehicle, and the manner of detecting the active voice in the vehicle is employed to improve the detecting accuracy.

To the device embodiments, since they are basically similar with method embodiments, the description is relatively simple, the related parts may be referred to that of the method embodiments.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the apparatus for recognizing advertisement plug-ins according to the embodiments of the present disclosure. The present disclosure may be further realized as some or all the equipment or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

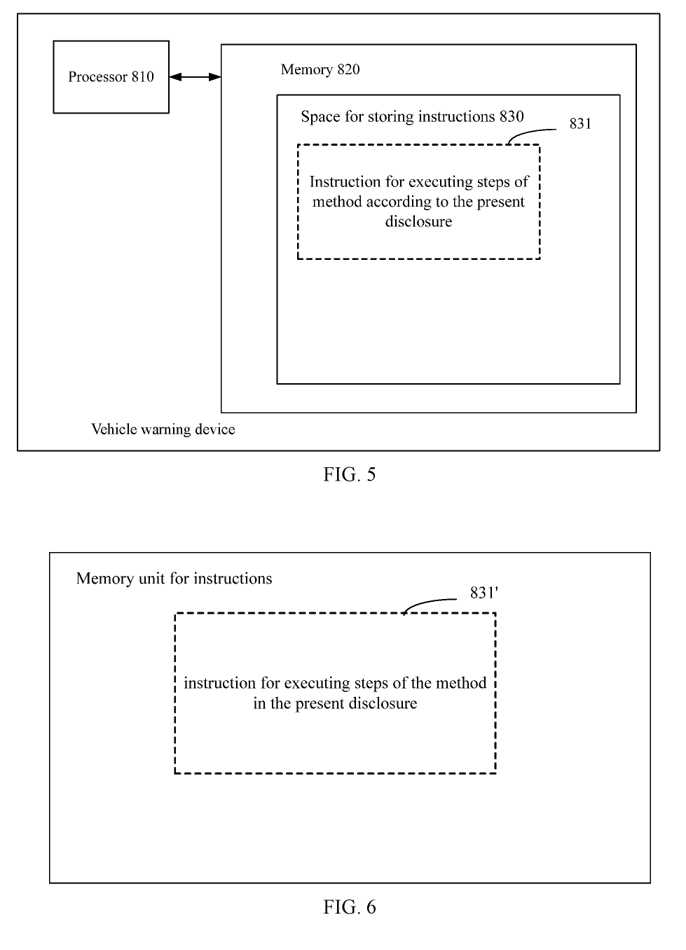

For example, FIG. 5 is a block diagram schematically showing a vehicle control device of the present disclosure. The vehicle control device includes a processor 810 and a computer program product or computer readable medium in the form of memory 820. The memory 820 may be an electronic memory such as a flash memory, EEPRPOM (electrically erasable programmable read-only memory), EPROM (electrically programmable read-only memory), hard disk or ROM (read-only memory). The memory 820 has a memory space 830 for storing instructions for executing any of the steps in the above method. For example, the memory space 830 for storing the instructions may include each instruction 831 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 5. The memory unit may have similar-arranged memory paragraph, memory space and the like as the memory 820 of the vehicle control device in FIG. 6. The instructions may be, for example, compacted in appropriate form. Generally, the memory unit includes a computer readable code 831′, that is, the code which may be read by processor such as the processor 810. When the instruction is executed by the vehicle device, the vehicle control device is made to execute the steps in the methods above.

The above embodiments are described merely for a schematic purpose, wherein the units explained as individual members may or may not be physically separated, the members shown as units may or may not be physical units and they can be placed at a position or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the purpose of illustrating not limiting the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A vehicle warning method comprising:
detecting whether an active voice exists inside a vehicle after determining the vehicle is locked;
sending a warning message if the active voice exists.

2. The method according to claim 1, wherein the step of detecting whether the active voice exists inside the vehicle comprises:
obtaining a mixed voice signal collected from interior of the vehicle, the mixed voice signal comprising useful voice signal generated inside the vehicle and noise signal transmitted from exterior of the vehicle to the interior of the vehicle;
filtering the noise signal in the mixed voice signal to obtain a to-be-detected voice signal;
detecting the to-be-detected voice signal to determine whether the active voice exists inside the vehicle.

3. The method according to claim 2, wherein the step of detecting the to-be-detected voice signal to determine whether the active voice exists inside the vehicle comprises:
calculating a power value of the to-be-detected voice signal in a preset time period;
comparing the power value with a preset power threshold value;
determining the active voice exists inside the vehicle if the power value is larger than the power threshold value.

4. The method according to claim 3, wherein the to-be-detected voice signal comprises a plurality of sampling points of voice, each sampling point corresponds to an amplitude value respectively,
the step of calculating the power value of the to-be-detected voice signal in the preset time period comprises:
calculating sum of squares of the amplitude values of the sampling points comprised in the to-be-detected voice signal in the preset time period, taking the sum of squares as the power value of the to-be-detected voice signal in the preset time period.

5. The method according to claim 1, wherein the step of sending the warning message comprises at least one step of:
sending a text warning message to a mobile terminal which establishes connection with the vehicle via wireless network;
starting a light of the vehicle to generate light warning message; and
starting an alarm of the vehicle to generate sound warning message.

6. A vehicle warning device comprising:
at least one processor;
a memory for storing at least one instruction executable by the processor;
wherein the processor is configured to:
detect whether an active voice exists inside a vehicle after determining the vehicle is locked; and
send a warning message if the active voice exists.

7. The device according to claim 1, wherein the processor is further configured to:
obtain a mixed voice signal collected from interior of the vehicle, the mixed voice signal comprising useful voice signal generated inside the vehicle and noise signal transmitted from exterior of the vehicle to the interior of the vehicle;
filter the noise signal in the mixed voice signal to obtain the to-be-detected voice signal; and
detect a to-be-detected voice signal to determine whether the active voice exists inside the vehicle.

8. The device according to claim 7, wherein the processor is further configured to:
calculate a power value of the to-be-detected voice signal in a preset time period; and
compare the power value with a preset power threshold value, and determine the active voice exists inside the vehicle if the power value is larger than the power threshold value.

9. The device according to claim 8, wherein the to-be-detected voice signal comprises a plurality of sampling points of voice, each sampling point corresponds to an amplitude value respectively,
the processor is further configured to calculate sum of squares of the amplitude values of the sampling points comprised in the to-be-detected voice signal in the preset time period, taking the sum of squares as the power value of the to-be-detected voice signal in the preset time period.

10. The device according to claim 6, wherein the processor is further configured to perform at least one of:
sending a text warning message to the mobile terminal which establishes connection with the vehicle via wireless network;
starting a light of the vehicle to generate light warning message; and
starting an alarm of the vehicle to generate sound warning message.
